(19) United States
(12) Patent Application Publication
(10) Pub. No.: US 2014/0321370 A1
(43) Pub. Date: Oct. 30, 2014

(54) RATE MATCHING UNDER IRREGULAR, SPARSE, OR NARROWBAND SIGNALS

(71) Applicant: QUALCOMM Incorporated, San Diego, CA (US)

(72) Inventors: Wanshi CHEN, San Diego, CA (US); Peter GAAL, San Diego, CA (US); Aleksandar DAMNJANOVIC, Del Mar, CA (US); Hao XU, San Diego, CA (US)

(73) Assignee: QUALCOMM INCORPORATED, San Diego, CA (US)

(21) Appl. No.: 14/196,475

(22) Filed: Mar. 4, 2014

Related U.S. Application Data
(60) Provisional application No. 61/817,265, filed on Apr. 29, 2013.

(51) Int. Cl. H04W 28/02

(52) U.S. Cl. CPC H04W 28/0252
USPC 370/329

(57) ABSTRACT

Aspects of the present disclosure relate to techniques that may be utilized to perform rate matching in networks which utilize sparsely or irregularly transmitted signals/channels.

### CROSS-REFERENCE TO RELATED APPLICATIONS

The present application for patent claims priority to U.S. Provisional Application No. 61/817,265, filed Apr. 29, 2013, which is assigned to the assignee of the present application and hereby expressly incorporated by reference herein in its entirety.

### FIELD

Certain embodiments of the present disclosure generally relate to wireless communication and, more particularly, to techniques for rate matching physical downlink shared channels under irregular, sparse, or narrowband channels and signals in long term evolution (LTE) wireless systems.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

Some systems may utilize a relay base station that relays messages between a donor base station and wireless terminals. The relay base station may communicate with the donor base station via a backhaul link and with the terminals via an access link. In other words, the relay base station may receive downlink messages from the donor base station over the backhaul link and relay these messages to the terminals over the access link. Similarly, the relay base station may receive uplink messages from the terminals over the access link and relay these messages to the donor base station over the backhaul link.

### SUMMARY

Certain aspects of the present disclosure provide a method for wireless communications by a user equipment (UE). The method generally includes receiving signaling providing an indication of whether the UE is to perform rate matching around one or more signals when decoding a downlink transmission, wherein different transmission points transmit the one or more signals based on one or more different configurations, and decoding the downlink transmission with or without rate matching around the one or more signals, based on the indication.

Certain aspects of the present disclosure provide a method for wireless communications by a transmission point (TP). The method generally includes signaling an indication, to a user equipment (UE) of whether the UE is to perform rate matching around one or more signals when decoding a downlink transmission, wherein the one or more signals occupy a fraction of a system bandwidth and different transmission points transmit the one or more signals based on one or more different configurations.

Certain aspects of the present disclosure provide various apparatuses and program products for performing the operations of the methods described above.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system, according to aspects of the present disclosure.

FIG. 2 is a block diagram of a communication system, according to aspects of the present disclosure.

FIG. 3 illustrates an example frame structure, according to aspects of the present disclosure.

FIG. 4 illustrates an example subframe resource element mapping, according to aspects of the present disclosure.

FIG. 5 illustrates continuous carrier aggregation, in accordance with certain aspects of the disclosure.

FIG. 6 illustrates non-continuous carrier aggregation, in accordance with certain aspects of the disclosure.

FIG. 7 illustrates example operations, in accordance with certain aspects of the disclosure.

FIG. 8 illustrates exemplary transmission resource allocations for two exemplary cells, according to aspects of the present disclosure.

FIG. 9A illustrates an example deployment scenario for small cells in LTE Release 12, in which aspects of the present disclosure may be practiced.

FIG. 9B illustrates example deployment scenarios for small cells in LTE Release 12, in which aspects of the present disclosure may be practiced.

FIG. 9C illustrates an example deployment scenario for small cells in LTE Release 12, in which aspects of the present disclosure may be practiced.

FIG. 10 illustrates example operations that may be performed by a user equipment (UE), according to aspects of the present disclosure.

FIG. 11 illustrates example operations that may be performed by a base station (BS), according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization, is a wireless transmission technique. SC-FDMA has similar performance and essentially the same overall complexity as those of an OFDMA system. SC-FDMA signal has lower peak-to-average power ratio (PAPR) because of its inherent single carrier structure. SC-FDMA has drawn great attention, especially in uplink communications where lower PAPR greatly benefits the mobile terminal in terms of transmit power efficiency. It is currently a working assumption for the uplink multiple access scheme in 3GPP Long Term Evolution (LTE), or Evolved UTRA.

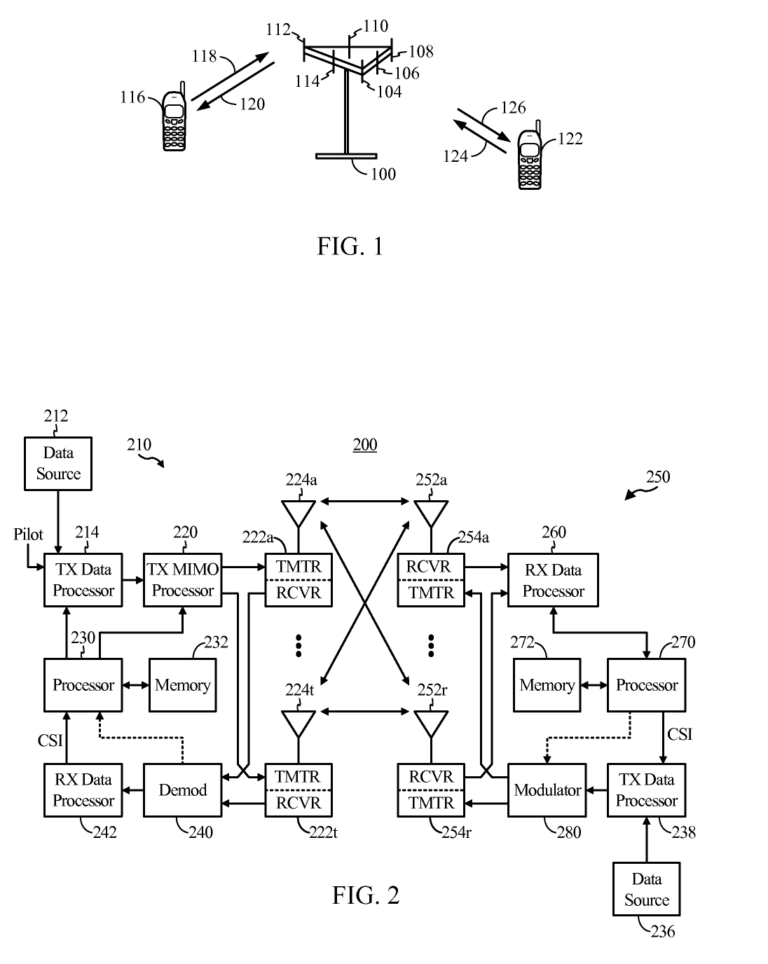

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a frequency division duplexing (FDD) system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, or some other terminology.

FIG. 2 is a block diagram of an embodiment of a transmitter system 210 (also known as an access point) and a receiver system 250 (also known as an access terminal) in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., binary phase shift keying (BPSK), quadrature phase shift keying (QPSK), M phase shift keying (M-PSK), or M quadrature amplitude modulation (M-QAM)) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r, and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

A receive (RX) data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights and then processes the extracted message.

In an aspect, logical channels are classified into Control Channels and Traffic Channels. Logical Control Channels comprise Broadcast Control Channel (BCCH), which is a downlink (DL) channel for broadcasting system control information. Paging Control Channel (PCCH) is a DL channel that transfers paging information. Multicast Control Channel (MCCH) is a point-to-multipoint DL channel used for transmitting Multimedia Broadcast and Multicast Service (MBMS) scheduling and control information for one or several Multicast Traffic Channels (MTCHs). Generally, after establishing an radio resource control (RRC) connection, this channel is only used by UEs that receive MBMS. Dedicated Control Channel (DCCH) is a point-to-point bi-directional channel that transmits dedicated control information used by UEs having an RRC connection. In an aspect, Logical Traffic Channels comprise a Dedicated Traffic Channel (DTCH), which is a point-to-point bi-directional channel, dedicated to one UE, for the transfer of user information. Also, a Multicast Traffic Channel (MTCH) is a point-to-multipoint DL channel for transmitting traffic data.

In an aspect, Transport Channels are classified into DL and UL. DL Transport Channels comprise a Broadcast Channel (BCH), Downlink Shared Data Channel (DL-SDCH), and a Paging Channel (PCH). The PCH may be used for support of discontinuous reception (DRX) by UEs. The use of DRX allows power savings by the UE (the DRX cycle is indicated by the network to the UE). The PCH is broadcasted over entire cell and mapped to physical layer (PHY) resources which can be used for other control/traffic channels. The UL Transport Channels comprise a Random Access Channel (RACH), a Request Channel (REQCH), an Uplink Shared Data Channel (UL-SDCH), and a plurality of PHY channels. The PHY channels comprise a set of DL channels and UL channels.

In an aspect, a channel structure is provided that preserves low PAPR (at any given time, the channel is contiguous or uniformly spaced in frequency) properties of a single carrier waveform.

For the purposes of the present document, the following abbreviations apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DL-SCH DownLink Shared CHannel

DM-RS DeModulation-Reference Signal

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RB Resource Block

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN Multimedia Broadcast Single Frequency Network

MCE MBMS Coordinating Entity

MCH Multicast CHannel

MSCH MBMS Control CHannel

PDCCH Physical Downlink Control CHannel

PDSCH Physical Downlink Shared CHannel

PRB Physical Resource Block

VRB Virtual Resource Block

In addition, Rel-8 refers to Release 8 of the LTE standard.

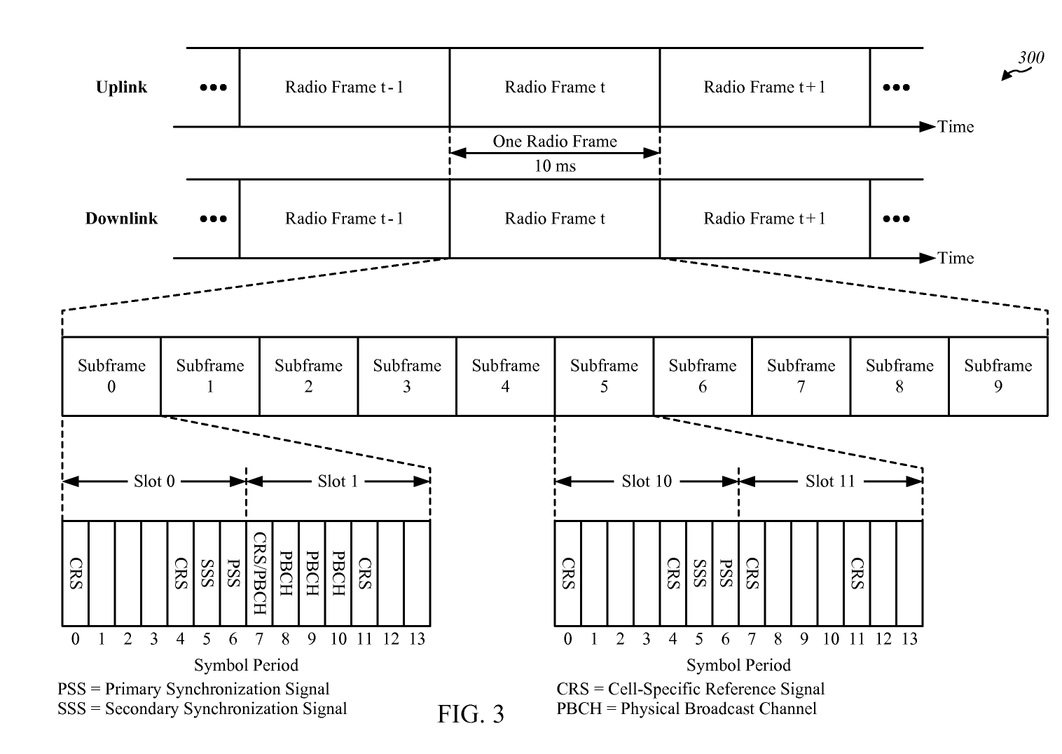

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 2) or six symbol periods for an extended cyclic prefix. The 2L symbol periods in each subframe may be assigned indices of 0 through 2L−1.

In LTE, an eNodeB may transmit a primary synchronization signal (PSS) and a secondary synchronization signal (SSS) on the downlink in the center 1.08 MHz of the system bandwidth for each cell supported by the eNodeB. The PSS and SSS may be transmitted in symbol periods 6 and 5, respectively, in subframes 0 and 5 of each radio frame with the normal cyclic prefix, as shown in FIG. 3. The PSS and SSS may be used by UEs for cell search and acquisition. During cell search and acquisition the terminal detects the cell frame timing and the physical-layer identity of the cell from which the terminal learns the start of the reference-signal sequence (given by the frame timing) and the reference-signal sequence of the cell (given by the physical layer cell identity). The eNodeB may transmit a cell-specific reference signal (CRS) across the system bandwidth for each cell supported by the eNodeB. The CRS may be transmitted in certain symbol periods of each subframe and may be used by the UEs to perform channel estimation, channel quality measurement, and/or other functions. The eNodeB may also transmit a Physical Broadcast Channel (PBCH) in symbol periods 0 to 3 in slot 1 of certain radio frames. The PBCH may carry some system information. The eNodeB may transmit other system information such as System Information Blocks (SIBs) on a Physical Downlink Shared Channel (PDSCH) in certain subframes. The eNodeB may transmit control information/data on a Physical Downlink Control Channel (PDCCH) in the first B symbol periods of a subframe, where B may be configurable for each subframe. The eNodeB may transmit traffic data and/or other data on a PDSCH in the remaining symbol periods of each subframe.

An eNodeB may adapt the code rate of data in a transmission such that the number of information and parity bits to be transmitted matches the resources (i.e., the number of PRBs) allocated to the transmission. This adaptation includes decreasing the code rate or puncturing bits when the resource allocation includes PRBs carrying PSS, SSS, CRS, or otherwise having symbols unavailable for conveying data. This adaption may be referred to as rate matching.

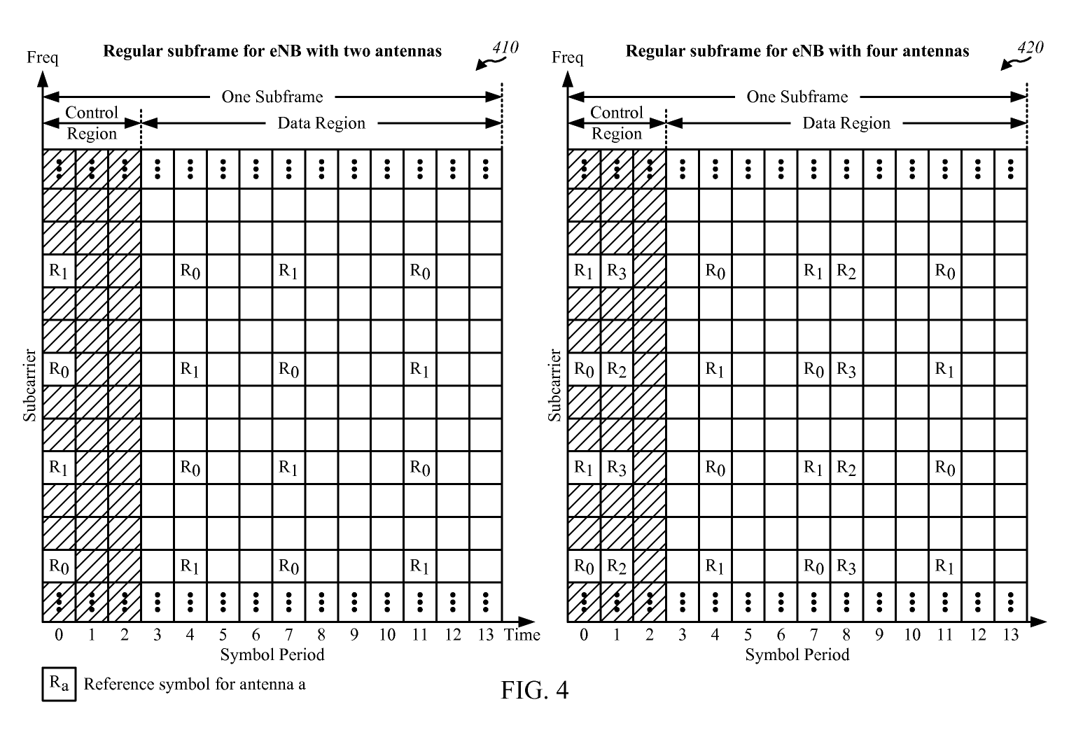

FIG. 4 shows two exemplary subframe formats 410 and 420 for downlink transmissions from an eNodeB using the normal cyclic prefix. The available time frequency resources for the downlink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

Subframe format 410 may be used for an eNodeB equipped with two antennas. A CRS may be transmitted from antennas 0 and 1 in symbol periods 0, 4, 7 and 11. A reference signal is a signal that is known a priori by a transmitter and a receiver and may also be referred to as a pilot. A CRS is a reference signal that is specific for a cell, e.g., generated based on a cell identity (ID). In FIG. 4, for a given resource element with label Rₐ, a modulation symbol (e.g., a CRS) may be transmitted on that resource element from antenna a, and no modulation symbols may be transmitted on that resource element from other antennas. Subframe format 420 may be used for an eNodeB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on cell ID. Different eNodeBs may transmit their CRSs on the same or different subcarriers, depending on their cell IDs. For both subframe formats 410 and 420, resource elements not used for the CRS may be used to transmit data (e.g., traffic data, control data, and/or other data).

The PSS, SSS, CRS, and PBCH in LTE are described in 3GPP TS 36.211, entitled “Evolved Universal Terrestrial Radio Access (E-UTRA); Physical Channels and Modulation,” which is publicly available.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q subframes. In particular, interlace q may include subframes q, q+Q, q+2Q, etc., where qε{0, . . . , Q−1}.

The wireless network may support hybrid automatic retransmission request (HARQ) for data transmission on the downlink and uplink. For HARQ, a transmitter (e.g., an eNodeB) may send one or more transmissions of a packet until the packet is decoded correctly by a receiver (e.g., a UE) or some other termination condition is encountered. For synchronous HARQ, all transmissions of the packet may be sent in subframes of a single interlace. For asynchronous HARQ, each transmission of the packet may be sent in any subframe.

A UE may be located within the coverage area of multiple eNodeBs. One of these eNodeBs may be selected to serve the UE. The serving eNodeB may be selected based on various criteria such as received signal strength, received signal quality, pathloss, etc. Received signal quality may be quantified by a signal-to-noise-and-interference ratio (SINR), a reference signal received quality (RSRQ), or some other metric. The UE may operate in a dominant interference scenario in which the UE may observe high interference from one or more interfering eNodeBs. For example, an eNodeB may restrict access to only a certain group of UEs. The group may be referred to as a closed subscriber group (CSG), and the restricting eNodeB may be referred to as a closed subscriber group eNodeB or cell. If a UE that is not a member of the CSG is near the CSG eNodeB, then the UE will receive signals from the CSG eNodeB at relatively high strength, while being denied access to the CSG eNodeB. The UE will attempt to associate with another eNodeB and receive service from the other eNodeB, while signals from the nearby CSG eNodeB will act as interference to communications between the UE and the serving eNodeB.

### Carrier Aggregation

LTE-Advanced UEs may use spectrum in bandwidths of up to 20 MHz allocated in a carrier aggregation of up to a total of 100 MHz (5 component carriers) for transmission in each direction. For LTE-Advanced mobile systems, two types of carrier aggregation (CA) methods have been proposed, continuous CA and non-continuous CA. Both non-continuous and continuous CA aggregate multiple LTE/component carriers to serve a single LTE-Advanced UE. According to various embodiments, a UE operating in a multicarrier system (also referred to as carrier aggregation) is configured to aggregate certain functions of multiple carriers, such as control and feedback functions, on the same carrier, which may be referred to as a “primary carrier.” The remaining carriers that depend on the primary carrier for support are referred to as associated secondary carriers. For example, a UE may aggregate control functions such as those provided by a dedicated channel (DCH), nonscheduled grants, a physical uplink control channel (PUCCH), and/or a physical downlink control channel (PDCCH). CA can improve overall transmission efficiency, in that only resources on the primary carrier are used for control functions, while all of the secondary carriers are available for data transmission. Thus, the ratio of transmitted data to control functions may be increased by CA, when compared to non-CA techniques.

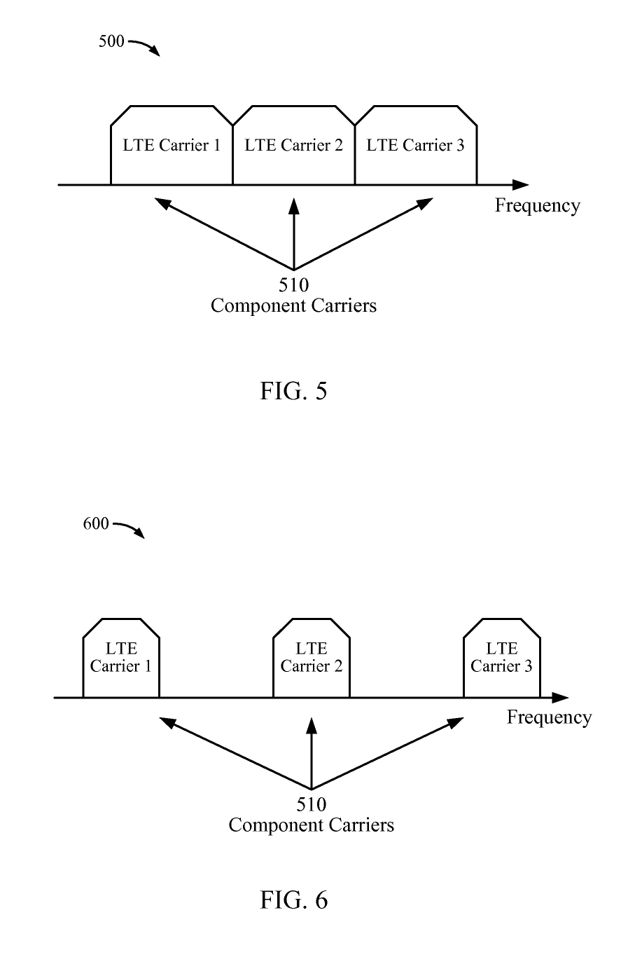

FIG. 5 illustrates continuous CA 500, in which multiple available component carriers 510 adjacent to each other are aggregated.

FIG. 6 illustrates non-continuous CA 600, in which multiple available component carriers 510 separated along the frequency band are aggregated.

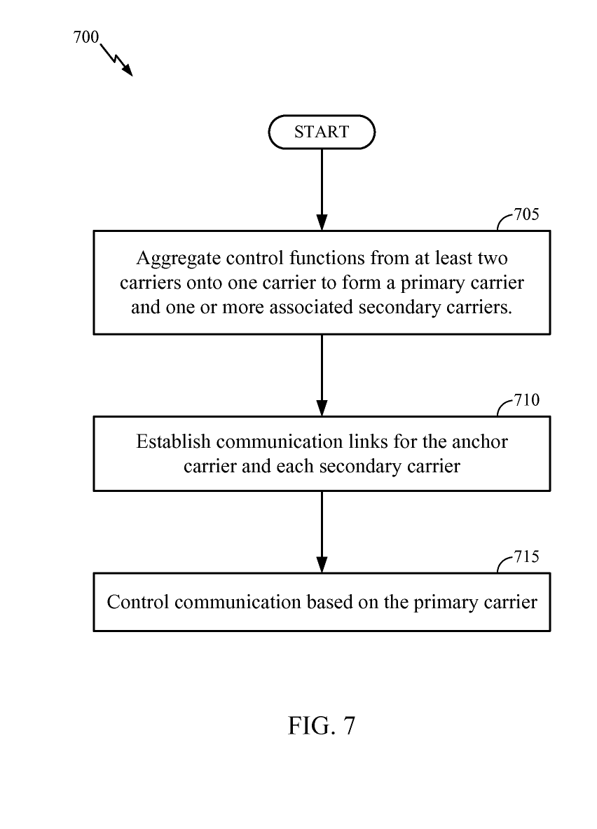

FIG. 7 illustrates a method 700 for controlling radio links in a multiple carrier wireless communication system by grouping physical channels according to one example. As shown, the method includes, at block 705, aggregating control functions from at least two carriers onto one carrier to form a primary carrier and one or more associated secondary carriers. For example, all of the control functions for component carriers 510a, 510b, and 510c in FIG. 5 may be aggregated on component carrier 510a, which acts as the primary carrier for the aggregation of carriers 510a, 510b, and 510c. Next at block 710, communication links are established for the primary carrier and each secondary carrier. For example, a UE associating with an eNodeB receives configuration information regarding the component carriers 510a, 510b, and 510c (e.g., bandwidth of each component carrier), and configuration information indicating mappings between control information to be received on primary carrier 510a and associated secondary carriers 510b and 510c. Then, communication is controlled based on the primary carrier in block 715. For example, an eNodeB may transmit a PDCCH to a UE on primary carrier 510a conveying a downlink grant to the UE for a PDSCH directed to the UE and transmitted by the eNodeB on secondary carrier 510b.

### New Carrier Type

Previously, LTE-Advanced (LTE-A) standardization has required carriers to be backward-compatible, which enabled a smooth transition to new releases. However, backward compatibility required cells to continuously transmit common reference signals (CRS, also referred to as cell-specific reference signals) on every carrier in every subframe across the bandwidth. Most cell site energy consumption is caused by the power amplifier, because the cell remains on even when only limited control signalling (e.g., CRS) is being transmitted, causing the amplifier to continue to consume energy. A new carrier type (NCT) allows temporarily switching off of cells by removing transmission of CRS in four out of five subframes. This reduces power consumed by the power amplifier. It also reduces the overhead and interference from CRS since CRS are not continuously transmitted in every subframe across the bandwidth. CRS were introduced in release 8 of LTE and are LTE's most basic downlink reference signal. They are transmitted in every resource block in the frequency domain and in every downlink subframe. CRS in a cell can be for one, two, or four corresponding antenna ports. CRS may be used by remote terminals to estimate channels for coherent demodulation. In addition, the new carrier type allows downlink control channels to be operated using UE-specific demodulation reference signals (UE-RS). The New Carrier Type might be operated as a kind of extension carrier along with another LTE/LTE-A carrier or alternatively as a standalone non-backward compatible carrier.

### An Example of PDSCH Rate Matching Under Irregular, Sparse, or Narrowband Channels and Signals in LTE

The control information sent on each physical downlink control channel (PDCCH) may convey one or more downlink grants, one or more uplink grants, power control information, and/or other information. In LTE Rel-8/9/10/11, each PDCCH follows a downlink control information (DCI) format. The different types of control information, both between the groups above as well as within the groups, correspond to different DCI message sizes. DCI is therefore categorized into different DCI formats. Downlink (DL) grant DCI formats may include formats 1, 1A, 1B, 1D, 2, 2A, 2B, 2C, and 2D. Uplink (UL) grant DCI formats may include formats 0 and 4. Broadcast/multicast DCI formats may include formats 1C, 3, and 3A. DCI formats are described in 3GPP TS 36.212, entitled “Evolved Universal Terrestrial Radio Access (E-UTRA); Multiplexing and Channel Coding,” which is publicly available.

In certain aspects, each DCI format contains a 16-bit CRC, which is masked by an identifier (ID) (e.g., a UE-specific ID or a broadcast/multicast ID). The size of the DCI may depend on system bandwidth, system type (FDD or TDD), number of common reference signal (CRS) antenna ports, DCI formats, whether carrier aggregation is being used, etc. The size of the DCI is typically tens of bits (e.g. 30˜70), including the CRC. A UE may determine that a DCI is intended for the UE by performing an unmasking operation utilizing the UE-specific ID (or a broadcast/multicast ID assigned to the UE, a paging indication ID, etc.) on the CRC, and determining if the DCI and unmasked CRC match (i.e., the unmasked CRC matches a CRC calculated from the DCI).

In addition, a UE may need to perform blind decodes to determine whether there are one or more PDCCHs addressed to it or not. A UE performs blind decoding on PDCCH candidates to determine which PDCCH candidates in a subframe are PDCCHs intended for the UE. The UE attempts blind decodes on PDCCH candidates from the common search space before attempting blind decodes on PDCCH candidates from the UE-specific search space. The size of a PDCCH can vary significantly; therefore, there may be a large number of PDCCH candidates in any given subframe. The number of blind decodes a UE performs on a subframe may be up to 44 in LTE Rel-8 and 9, and up to 60 in LTE Rel-10 if UL MIMO is configured.

The development of enhanced physical downlink control channels (EPDCCH) was motivated by multiple work items in Rel-11, including cooperative multi-point (CoMP), DL multiple-input multiple-output (MIMO) enhancements, further enhanced inter-cell interference coordination (ICIC), and New Carrier Type (NCT, which was later postponed to Rel-12). EPDCCH is frequency division multiplexing (FDM) based. Only demodulation reference signal (DM-RS) based EPDCCH is supported. Although the number of DM-RS resource elements (REs) for PDSCH are dependent on PDSCH ranks (e.g., 12 DM-RS REs for rank 1 and rank 2 PDSCH transmissions, and 24 DM-RS REs for rank 3 and above PDSCH transmissions in the normal cyclic prefix case), for simplicity, the design of EPDCCH always assumes a maximum presence of DM-RS REs by assuming 24 DM-RS REs in the normal cyclic prefix (CP) case (i.e., an eNodeB will not transmit an EPDCCH using REs that would be used for DM-RS when transmitting rank 3 and above PDSCH, even if the eNodeB is not transmitting rank 3 or higher PDSCH and the DM-RS REs will not be used). EPDCCH uses four possible antenna ports—107, 108, 109 and 110—corresponding to the ports used for DM-RS.

Two operation modes for EPDCCH are supported. The first mode is localized EPDCCH, in which a single precoder is applied for each physical resource block (PRB) pair. The second mode is distributed EPDCCH, in which two precoders cycle through the allocated resources within each PRB pair, where a PRB pair refers to two PRBs on the same subcarriers in the two slots of a single subframe. The physical resource block (PRB) represents the minimum allocation of symbols and subcarriers. In LTE, one subframe of 1 ms corresponds to two resource blocks. Each physical resource block in LTE is made up of 12 subcarriers for 7 symbols (when using the Normal Cyclic Prefix) or 6 symbols (when using the Extended Cyclic Prefix).

Each UE can be configured with up to 2 EPDCCH resource sets, where each resource set is separately configured with 2, 4, or 8 PRB pairs. Each resource set is also separately configured with either localized or distributed mode. An EPDCCH search space is defined within each EPDCCH resource set. For example, a first UE may be configured by the serving network with EPDCCH resource set A, consisting of 2 PRB pairs and configured for localized mode, and resource set B, consisting of 4 PRB pairs and configured for distributed mode. A second UE may be configured with resource set C, configured for distributed mode, and resource set D, configured for localized mode, with each set consisting of 4 PRB pairs. Each of resource sets A, B, C, and D may have a different EPDCCH search space defined.

New Carrier Type (NCT) may be defined in LTE Rel-12. NCT may be supported in the context of carrier aggregation (CA) as one or more associated secondary carriers in a CA system. As discussed above, a NCT carrier used as an associated secondary carrier may not carry PBCH, PDCCH, EPDCCH, and may have a reduced number of CRS when compared to the primary carrier. Standalone (i.e., not aggregated with other carriers) NCT carriers may also be supported in LTE Rel-12.

As discussed above, NCT has reduced CRS overhead when compared to legacy carrier type (LCT). In NCT, CRS may be transmitted only once every 5 ms (vs. in every subframe in LCT), and using 1 port (vs. up to 4 CRS ports in LCT). In NCT, CRS may not be used for demodulation. CRS in NCT may be used for time/frequency tracking and/or reference signal received power (RSRP) measurement.

In NCT, it may be possible to have a new DM-RS pattern (differing from the DM-RS pattern defined for LCT), or transmit PSS and SSS using frequency and time resources which differ from the resources used in Rel-8/9/10/11 and illustrated in FIG. 3, in order to avoid collisions between DM-RS and PSS or SSS. By using different transmission resources for DM-RS or PSS and SSS, DM-RS based PDSCH/EPDCCH transmissions may be allowed in the center 6 RBs in subframes carrying PSS/SSS/PBCH.

In legacy carrier type (LCT), CRS are transmitted in each subframe. Also in LCT, a UE is semi-statically configured (e.g., via RRC signaling) with a DL transmission mode. Transmission modes in LTE are described in 3GPP TS 36.213, entitled “Evolved Universal Terrestrial Radio Access (E-UTRA); Physical Layer Procedures,” which is publicly available. Two DCI formats for DL grants are associated with each DL transmission mode. One DCI format is DCI format 1A (compact DCI format), and the other DCI format is DL transmission mode dependent (e.g., DCI format 2D if DL transmission mode 10). Compact DCI format 1A is more DL control overhead efficient than other DCI formats, and may schedule rank 1 PDSCH transmissions. DCI format 1A typically schedules CRS based space frequency block code (SFBC) PDSCH transmissions.

In multimedia broadcast single frequency network (MBSFN) subframes, where CRS is not present in the MBSFN region of the MBSFN subframes, UE-RS based PDSCH transmissions may be scheduled by DCI format 1A, which is associated with a single antenna port (e.g., port 5 or port 7, depending on DL transmission mode).

In Rel-11, Coordinated multipoint transmission schemes (CoMP) are supported, which refer to schemes where multiple base stations coordinate transmissions to (DL CoMP) or receptions from (UL CoMP) one or more UEs. DL CoMP and UL CoMP can be separately or jointly enabled for a UE. Some examples of CoMP schemes are joint transmission (JT) (DL CoMP), where multiple eNodeBs transmit the same data meant for a UE; joint reception (UL CoMP), where multiple eNodeBs receive the same data from a UE; coordinated beamforming (CBF), where an eNodeB transmits to its UE using beams that are chosen to reduce interference to UEs in neighboring cells; and dynamic point(s) selection (DPS), where the cell(s) involved in data transmissions may change from subframe to subframe (e.g., a UE may receive from cell 1 in subframe 0, receive from cell 2 in subframe 1, receive from cell 1 again in subframes 2-3, receive from cell 2 again in subframe 4, etc.).

CoMP may exist in homogeneous networks and/or heterogeneous networks (HetNet). Homogeneous network refers to a network in which all nodes are of a similar capacity (i.e., all nodes support macro cells), while heterogeneous network refers to a network which has nodes of widely varying capacity (e.g., macro cells, pico cells, femto cells, etc.). The connection between the nodes involved in CoMP can be via an X2 interface (implying some latency and limited bandwidth) or a fiber-optic interface (implying minimal latency and virtually unlimited bandwidth). In HetNet CoMP, low power nodes, sometimes also called remote radio heads (RRH), may be implemented by a network operator to support UEs in areas which have poor coverage from the network's standard eNodeBs. One or more low power nodes may coordinate with a standard eNodeB to perform CoMP. Low power nodes may also coordinate with other low power nodes when performing CoMP, depending on channel and traffic conditions.

One or more virtual cell IDs may be configured for PDSCH for a UE to enable more efficient CoMP operation. Use of a virtual cell ID allows a UE to combine signals received simultaneously from multiple nodes (i.e., JT DL CoMP) as if they were transmitted by a single node. Use of a virtual cell ID also allows a UE to treat transmissions received from multiple nodes at different times (i.e., DPS DL CoMP) as if the transmissions were part of a single ongoing communication involving only a single connection. The nodes may continue to use their physical cell ID for transmissions to other UEs not involving CoMP. According to certain aspects, a UE may acquire dynamic indications of which virtual cell ID to use for PDSCH in a subframe.

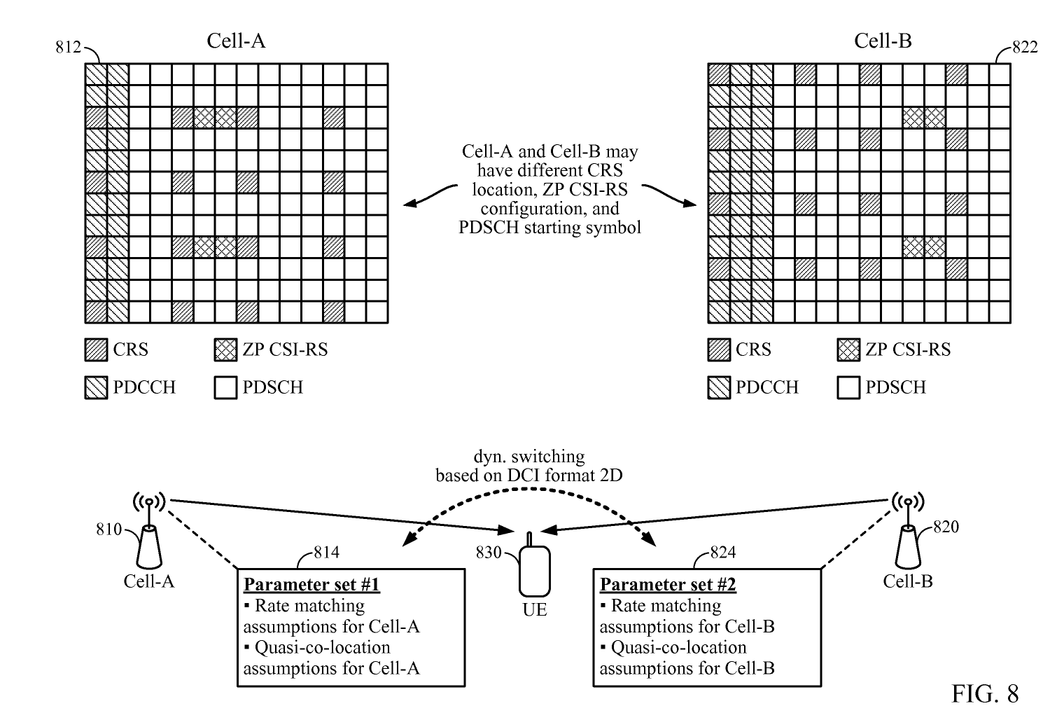

FIG. 8 illustrates exemplary transmission resource allocations 812 and 822 for two exemplary cells 810 and 820. As illustrated, cells may use differing transmission resources for CRS, zero power (ZP) CSI-RS, and the PDSCH starting symbol (e.g., one cell may transmit a PDCCH in only the first symbol and use the second symbol as the PDSCH starting symbol, while another cell may transmit PDCCH in the first two symbols and use the third symbol as the PDSCH starting symbol). To facilitate dynamic switching between transmission points (TPs) with different rate matching behavior, the UE 830 may be informed of the number of CRS ports and CRS frequency shift, ZP CSI-RS configuration, and PDSCH starting symbol for each cell. The UE may receive information regarding CRS ports, frequency shifts, ZP CSI-RS, and PDSCH starting symbol (e.g., parameter set 814, used by cell 810, and parameter set 824, used by cell 820), from upper layer signaling, for example. The UE may receive an indication of which parameter set to use for reception in each subframe.

The different multi-antenna transmission schemes correspond to so-called transmission modes. Transmission mode 1 (i.e., TM1) corresponds to single-antenna transmission, while the remaining transmission modes correspond to different multi-antenna transmission schemes. With transmission mode 10, TM10, DCI format 2D is introduced. DCI format 2D includes two PDSCH resource element mapping and quasi-co-location indicator (PQI) bits. According to some aspects, the two PQI bits may indicate one of four rate matching parameter sets. For example, a DCI format 2D with the two PQI bits set to 01 may indicate to a receiving UE that the UE should begin using rate matching parameter set 814, while 10 may indicate rate matching parameter set 824. The four rate matching parameter sets may be configured at the UE by higher communication layers, for example. The TM10 fallback behavior is aligned with TM9 operations, in that DCI format 1A received in an MBSFN subframe indicates use of a single-antenna port, port 7. Thus, a UE configured for TM10 can receive a DCI format 1A and transmit as if it were configured for TM9. If the DCI is received in a non-MBSFN subframe and the number of PBCH antenna ports is one, then the UE may use a single-antenna port, port 0. If the DCI is received in a non-MBSFN subframe and there are multiple PBCH antenna ports, then the UE uses transmit diversity.

EPDCCH may not rely on dynamic signaling of rate matching and quasi-co-location (QCL) assumptions. Therefore, to enable dynamic transmission point selection (i.e., DPS) while using EPDCCH, these rate matching and QCL assumptions may instead be tied to the two EPDCCH sets configured for a UE. Each EPDCCH set may be defined as a group of PRB pairs. When decoding EPDCCH, different rate matching and QCL assumptions may be made by a UE, depending on the respective EPDCCH set. For example, a UE may be configured to use rate matching parameter set 1 when an EPDCCH is received in EPDCCH resource set A, and rate matching parameter set 2 when an EPDCCH is received in EPDCCH resource set B. The PQI sets used for PDSCH rate matching and QCL may be reused to create a direct linkage between EPDCCH rate matching and PQI states.

The EPDCCH starting symbol may likewise be linked to the PQI states defined for PDSCH. For example, a DCI format 2D with PQI bits set to 01 may indicate to a UE that the EPDCCH starting symbol is symbol 1.

The configuration for semi-persistent scheduling (SPS) may be the same as the configuration described above for non-semi-persistent scheduling. The same sets of RRC parameters may be used for PDSCH transmissions whether or not a corresponding PDCCH or EPDCCH schedules the PDSCH. The RRC parameters include virtual cell IDs (VCIDs) for DM-RS and PQI sets containing PDSCH RE mapping and QCL parameters. The VCID and PQI parameters signaled during SPS activation may continue to apply to subsequent SPS transmissions whether a DCI format 2D or DCI format 1A was used for SPS activation.

### Example Lte Release 12 Deployment Scenarios for Small Cells

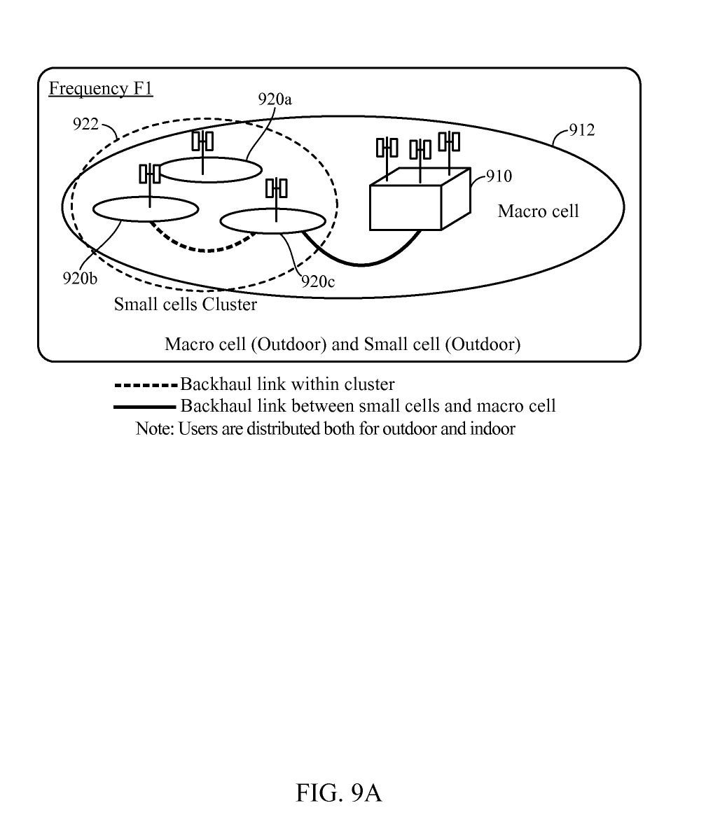

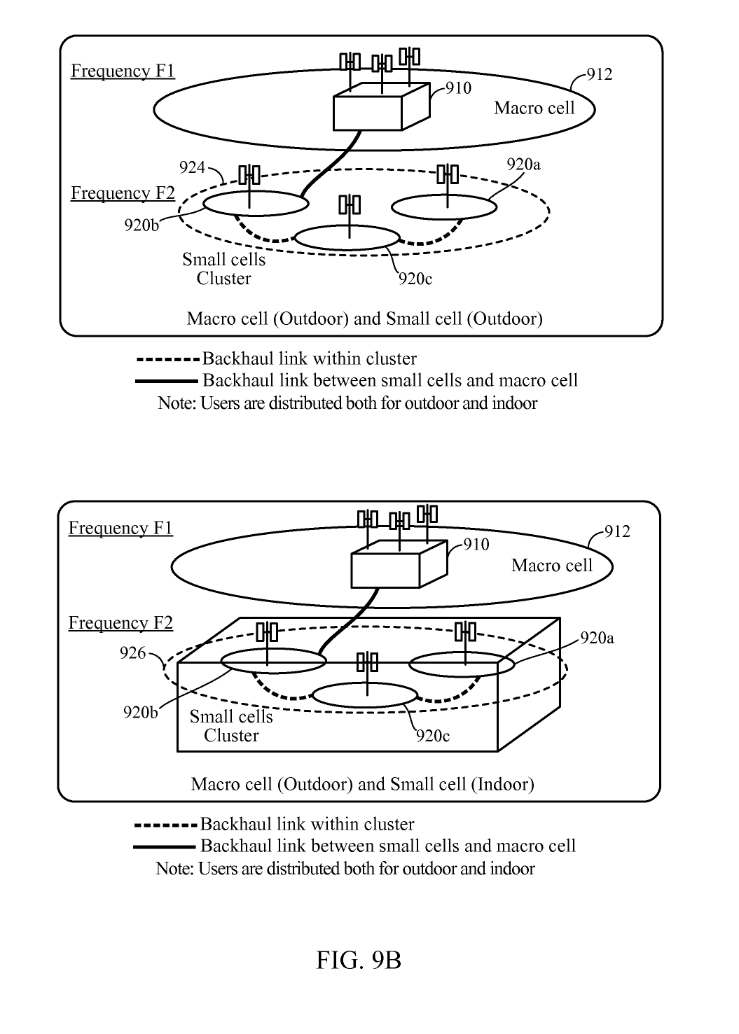

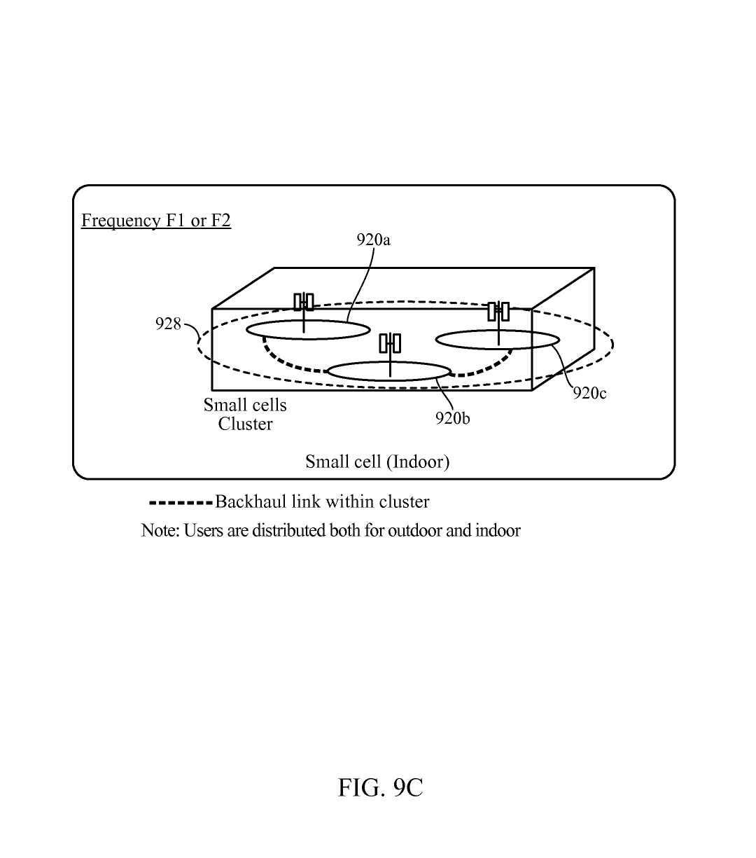

FIGS. 9A, 9B, and 9C illustrate example deployment scenarios for small cells (e.g., pico and femto cells in a HetNet) in LTE Release 12. In some cases, to enhance coverage and service, it may be desirable to have a deployment of small cells 920 in addition to a macro cell 910. These deployments may include, for example, small cells which operate on the same frequency band (F1) as a macro cell as in FIG. 9A, or on a different frequency band (F2) as in FIG. 9B.

Small cell deployments may also include small cell clusters which cover an area 922 within a macro cell's area 912, as in FIG. 9A, or an area 924, 926, 928 that is outside of a macro cell's area, as in FIGS. 9B and 9C. As an example, a network operator may choose to deploy a small cell cluster within a macro cell's area 912 in order to improve service in the small cell cluster's area 922. The small cell cluster's area may be at the edge of the macro cell's area, for example. A network operator may choose to deploy a small cell cluster outside of a macro cell's area to extend service to an area 924 with too few users to justify deploying a macro cell, for example.

Small cell deployments may also include a cluster of small cells that is not directly linked to a macro cell, as in FIG. 9C. For example, a network operator may choose to deploy a small cell cluster that is not directly linked to a macro cell to provide service to an area where a large number of users may gather, such as a stadium.

According to certain aspects, it is possible that small cells transmit some signals irregularly or sparsely. The sparsely or irregularly transmitted signals/channels may be PSS/SSS, PBCH, evolved PBCH (EPBCH), discovery signals, other forms of synchronization signals, reference signals, etc. These signals/channels may be irregular and/or sparse, and/or transmitted in a narrowband portion of a larger system bandwidth. For example, small cells 920a, 920b, and 920c in FIG. 9A may transmit PSS, SSS, and PBCH sparsely, while the macro cell 910 continues regular transmission of PSS, SSS, and PBCH.

As an example, PSS or SSS may not be transmitted every 5 ms as in Rel-8/9/10/11. Instead, PSS or SSS may be transmitted in an irregular or a sparse manner, e.g., PSS or SSS may be transmitted by a cell in N frames, followed by no transmission in the next M frames, and repeat this activity over time. N and M may be variables whose values are changed from time to time. An exemplary set of values for {N, M} could be {1, 9}, such that PSS or SSS are transmitted once every 10 frames.

According to certain aspects, small cells may have different periodicities, transmission subframes, or frame offsets. For example {N, M} could be {1, 1}, causing a small cell to transmit in every other frame. However, small cell 1 may transmit in even frames while small cell 2 may transmit in odd frames, for example. Having small cells 1 and 2 transmit their PSS or SSS in differing frames may allow some reuse and improve PSS or SSS interference mitigation.

According to certain aspects, PBCH or EPBCH may not be transmitted every 10 ms (i.e., every frame), as in Rel-8/9/10/11. Instead, PBCH or EPBCH may be transmitted in an irregular or a sparse manner, e.g., PBCH or EBCH may be transmitted by a cell in J frames, followed by no transmission in the next K frames, and repeat this activity over time. An exemplary set of values for {J, K} could be {1, 9}, such that PBCH or EPBCH are transmitted once every 10 frames. J and K may be identical to N and M as used in transmitting PSS and SSS, or may be different values. According to certain aspects, PBCH may be transmitted in certain frames, while EPBCH are transmitted in other frames.

According to certain aspects, a cell may be associated with one or more configurations of irregular or sparse signal transmissions. For example, a small cell may be associated with configuration 1: {N, M}={1, 9}, and configuration 2: {N, M}={1, 0}, where PSS/SSS is transmitted every 10 frames when the small cell is using configuration 1, and PSS/SSS is transmitted every frame when the small cell is using configuration 2.

The present disclosure provides various techniques that may be beneficial in such (i.e. small cell) deployments. One desirable feature of such a deployment is for the deployment to support cooperative multi-point (CoMP) communication methods while some cells may be transmitting irregular or sparse signals or channels. Techniques for supporting CoMP will be especially important for the center 6 RBs carrying PSS/SSS/PBCH, because NCT allows PDSCH in those RBs, whereas Rel-8/9/10/11 did not allow PDSCH in those RBs.

According to certain aspects, a UE is indicated whether to rate match around signals/channels that are irregularly or sparsely transmitted, particularly, PSS, SSS, or PBCH. For example, a UE may receive an indication to rate match around PSS and SSS in frames 1, 6, 11, etc. for transmissions received from node 1. The UE may also receive an indication to rate match around PSS and SSS in frames 3, 13, 23, etc. for transmissions received from node 2.

According to certain aspects, a UE may receive the indication from one of a group of transmission points (TPs) of whether to rate match around irregularly or sparsely transmitted signals/channels. The TP may be any type of TP, for example, a NodeB, an eNodeB, or a base station (BS). For example, a UE may receive an indication to rate match around PBCH in frames 2, 7, 12, etc. for transmissions received from cells 1, 2, and 3.

According to certain aspects, the indication can be dynamic or semi-static, or a combination thereof. For example, a UE may receive in a DCI an indication of the presence or absence of signals/channels. As another example, a UE may be configured with two or more configurations for the signals/channels, and be indicated which configuration to use in a particular subframe. The UE may receive the indication from upper layer signaling or from a DCI, for example.

According to certain aspects, a UE may be configured with a semi-static indication of whether to rate match around signals/channels. The configuration may be for all subframes, or it may be subframe-dependent. For example, a UE may be configured to rate match around PSS and SSS in subframes 5 and 6 of frames 1, 6, 11, etc., while not rate matching around PSS and SSS in other subframes.

According to certain aspects, the decision of whether to rate match may be based on the semi-static indication in combination with other information. For example, the decision of whether to rate match may depend on the configuration and the system frame number, subframes indices, or a signaled status of a cell. The status may be signaled from the same cell or a different cell. The signal may indicate the status of the cell is regular and rate matching may be done in a regular manner, or the signal may indicate the status of the cell is non-regular, and rate matching may be done in an irregular or sparse manner.

According to certain aspects, a UE may determine based on an indicated configuration whether rate matching around signals/channels is to be performed in a given subframe.

The indication of a configuration may be provided by any (or a combination of) a variety of signaling mechanisms. According to certain aspects, the indication of whether to rate-match may be part of a PQI indication, e.g. in the two PQI bits in a DCI format 2D. According to certain aspects, the indication of whether to rate match may be UE-specific, cell-specific or a combination of both. According to certain aspects, the indication of whether to rate match may be unicast (i.e., transmitted in a UE-specific message) or broadcast. For example, a small cell may broadcast an indication not to rate match in a DCI using a broadcast ID so that all of the small cell's served UEs will receive the indication.

According to certain aspects, the indication of whether to rate match may be explicit or implicit, or a combination thereof. For example, a UE may receive an indication that cells with odd physical cell ID (PCI) values transmit PSS/SSS in odd frames, and cells with even PCI values transmit PSS/SSS in even frames. A UE may determine whether or not rate matching is necessary based on the configuration, the PCI of the cell, and the frame number.

The techniques described herein may be performed to selectively rate match around various types of discovery signals. Such discovery signals may be aligned with paging subframes. This alignment may be in a same set of subframes (as paging subframes), or with a pre-determined relationship to paging subframes, e.g., discovery signals are transmitted in subframes 2 subframes after paging subframes. This approach may help improve (e.g., higher throughput or connection reliability) discontinuous transmission (DTX) operation for small cells.

The techniques described herein may be performed to selectively rate match around discovery signals for small cells, such as discovery signals in the form of PSS/SSS (e.g., but more sparse than the current PSS/SSS periodicity) or some new signals. For dormant cells, a reduced number of discovery signals may be transmitted, compared to active cells. For active cells, regular PSS/SSS may be transmitted (along with other discovery signals, if new discovery signals are supported).

Thus, from a rate matching perspective, whether to rate match or not may depend on the status of the cell. If active, rate matching around PSS/SSS/discovery signals may be performed based on a first configuration. If dormant, rate matching around discovery signals (which could be decimated PSS/SSS, if no new discovery signals are supported) may be performed based on a second configuration.

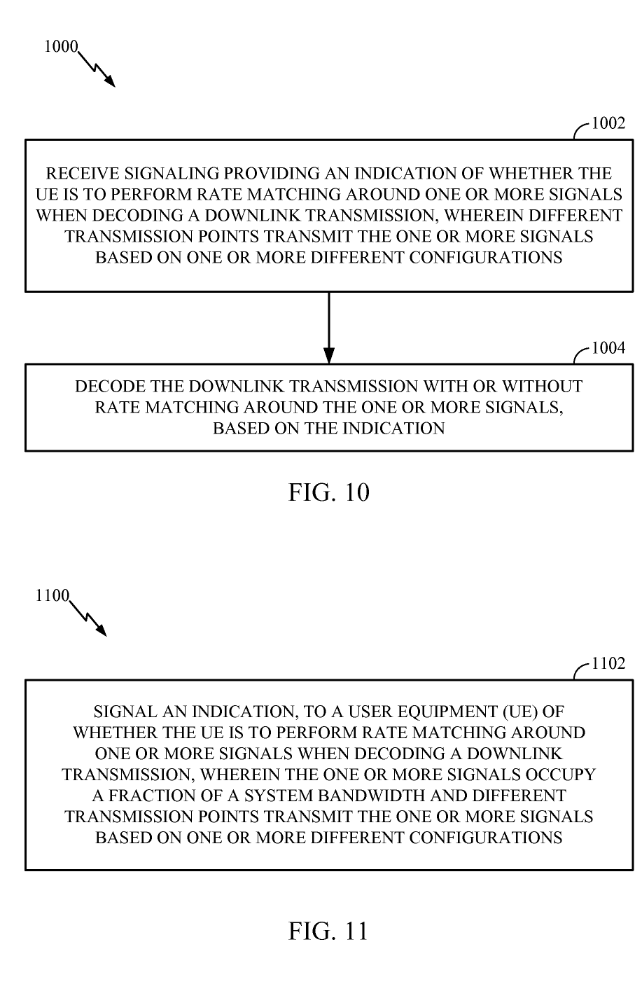

FIG. 10 illustrates example operations 1000 that may be performed by a UE, in accordance with certain aspects of the present disclosure.

The operations 1000 may begin, at 1002, by the UE receiving signaling providing an indication of whether the UE is to perform rate matching around one or more signals when decoding a downlink transmission, wherein different transmission points transmit the one or more signals based on one or more different configurations. For example, the UE may receive a configuration set from upper layer signaling indicating a TP does not transmit PSS and SSS in odd-numbered frames. At 1004, the UE may decode the downlink transmission with or without rate matching around the one or more signals, based on the indication. For example, the UE may receive a downlink transmission from the TP in an even-numbered frame and decode the transmission without rate matching around PSS and SSS.

FIG. 11 illustrates example operations 1100 that may be performed by a transmission point (TP), such as some type of base station (BS), in accordance with certain aspects of the present disclosure. In other words, the operations 1100 may be considered complementary to those shown in FIG. 10.

At 1102, the TP signals an indication to a user equipment (UE) indicating whether the UE is to perform rate matching around one or more signals when decoding a downlink transmission, wherein one or more signals occupy a fraction of a system bandwidth and different transmission points transmit the one or more signals based on one or more different configurations. For example, a TP may transmit a configuration indicating small cells only transmit PSS and SSS in one of every ten frames when the small cells are “inactive,” and a list of small cells which are currently “inactive.”

The various operations of methods described above may be performed by any suitable combination of hardware and/or software component(s) and/or module(s).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for wireless communications by a user equipment (UE), comprising:
receiving signaling providing an indication of whether the UE is to perform rate matching around one or more signals when decoding a downlink transmission, wherein the one or more signals occupy a fraction of a system bandwidth and the one or more signals are based on one or more different configurations; and
decoding the downlink transmission with or without rate matching around the one or more signals, based at least in part on the indication of the fraction of the system bandwidth occupied by the one or more signals, and the one or more different configurations of the one or more signals.

2. The method of claim 1, wherein the one or more different configurations are associated with different transmission points.

3. The method of claim 1, wherein at least one of the one or more different configurations determines how often a transmission point transmits the at least one of the one or more signals in a given set of subframes.

4. The method of claim 1, wherein each configuration is defined by at least:
a first variable indicating a number of frames in which the one or more signals are transmitted; and
a second variable indicating a number of frames in which the one or more signals are not transmitted.

5. The method of claim 1, wherein:
at least two configurations are associated with one or more transmission points; and
the signaling indicates at least one of the at least two configurations.

6. The method of claim 1, wherein the one or more signals comprise at least one of a primary synchronization signal (PSS), a secondary synchronization signal (SSS), a physical broadcast channel (PBCH), an evolved PBCH (EPBCH), or a control channel.

7. The method of claim 1, further comprising:
determining whether or not to perform rate matching based, at least in part, on one or more of a system frame number, a subframe index, or a signaled status of a cell.

8. The method of claim 1, wherein the indication is at least one of a UE-specific message or a broadcast message.

9. The method of claim 1, wherein the indication is based, at least in part, on a physical cell ID (PCI) of a cell.

10. The method of claim 1, wherein the indication is provided via one or more bits in a downlink control information (DCI).

11. The method of claim 10, wherein the one or more bits comprises one or more quasi-co-location indicator (PQI) bits.

12. The method of claim 1, wherein the fraction of the system bandwidth occupied by the one or more signals comprises frequency resources in a center of the system bandwidth.

13. A method for wireless communications by a transmission point (TP), comprising:
signaling an indication to a user equipment (UE) of whether the UE is to perform rate matching around one or more signals when decoding a downlink transmission, wherein the one or more signals occupy a fraction of a system bandwidth and the one or more signals are based on one or more different configurations.

14. The method of claim 13, wherein the one or more different configurations are associated with different transmission points.

15. The method of claim 13, wherein at least one of the one or more different configurations determines how often a transmission point transmits the at least one of the one or more signals in a given set of subframes.

16. The method of claim 13, wherein each configuration is defined by at least:
a first variable indicating a number of frames in which the one or more signals are transmitted; and
a second variable indicating a number of frames in which the one or more signals are not transmitted.

17. The method of claim 13, wherein:
at least two configurations are associated with one or more transmission points; and
the indication indicates at least one of the at least two configurations.

18. The method of claim 13, wherein the one or more signals comprise at least one of a primary synchronization signal (PSS), a secondary synchronization signal (SSS), a physical broadcast channel (PBCH), an evolved PBCH (EPBCH), or a control channel.

19. The method of claim 13, wherein the indication is based, at least in part, on one or more of a system frame number, a subframe index, or a signaled status of a cell.

20. The method of claim 13, wherein the indication is at least one of a UE-specific message or a broadcast message.

21. The method of claim 13, wherein the indication is based, at least in part, on a physical cell ID (PCI) of a cell.

22. The method of claim 13, wherein the indication is provided via one or more bits in a downlink control information (DCI).

23. The method of claim 22, wherein the one or more bits comprises one or more quasi-co-location indicator (PQI) bits.

24. The method of claim 17, wherein the fraction of the system bandwidth occupied by the one or more signals comprises frequency resources in a center of the system bandwidth.

25. An apparatus for wireless communications, comprising:
at least one processor configured to:
receive signaling providing an indication of whether to perform rate matching around one or more signals when decoding a downlink transmission, wherein the one or more signals occupy a fraction of a system bandwidth and the one or more signals are based on one or more different configurations; and
decode the downlink transmission with or without rate matching around the one or more signals, based at least in part on the indication, the fraction of the system bandwidth occupied by the one or more signals, and the one or more different configurations of the one or more signals; and
a memory coupled to the at least one processor.

26. An apparatus for wireless communications, comprising:
at least one processor configured to:
signal an indication to a user equipment (UE) of whether the UE is to perform rate matching around one or more signals when decoding a downlink transmission, wherein the one or more signals occupy a fraction of a system bandwidth and the one or more signals are based on one or more different configurations; and
a memory coupled to the at least one processor.
